(19) United States
(12) Patent Application Publication
(10) Pub. No.: US 2010/0178792 A1
(43) Pub. Date: Jul. 15, 2010

(54) CONNECTOR SYSTEM FOR CONNECTING CABLES TO A BATTERY

(76) Inventor: Richard Petersen, Belleville, MI (US)

Correspondence Address: BLANK ROME LLP, WATERGATE, 600 NEW HAMPSHIRE AVENUE, N.W., WASHINGTON, DC, 20037, US

(21) Appl. No.: 12/445,989

(22) PCT Filed: Oct. 19, 2007
(86) PCT No.: PCT/US07/81957

§ 371 Date: Mar. 30, 2010

Related U.S. Application Data
(60) Provisional application No. 60/852,663, filed on Oct. 19, 2006.

(51) Int. Cl. H01R 13/64; H01R 13/40; H01R 13/627; H01R 13/58

(52) U.S. Cl. 439/355; 439/884; 439/733.1; 439/445

(57) ABSTRACT

A connector system that connects cables to terminals of an electrical device. The connector system includes a first cable connector for terminating a first cable, a first terminal connector mateable with the first cable connector, a second cable connector for terminating a second cable, and a second terminal connector mateable with the second cable connector. The first terminal connector is configured to connect to a first terminal of the electrical device, and the second terminal connector is configured to connect to a second terminal of the electrical device. The first cable connector and the second cable connector are different so that the first cable connector is not mateable with the second terminal connector and the second cable connector is not mateable with the first terminal connector.

### CROSS-REFERENCE TO RELATED APPLICATION

This application claims priority under 35 U.S.C. §119(e) to U.S. Provisional Patent Application No. 60/852,663, entitled “Connector System for Connecting Cables to a Battery” by Richard W. Petersen, filed on Oct. 19, 2006, the entire disclosure of which is incorporated herein by reference.

### FIELD OF THE INVENTION

The present invention relates to a connector system for connecting cables to an electrical device. In particular, the connector system includes non-interchangeable cable connectors and terminal connectors.

### BACKGROUND OF THE INVENTION

When connecting an electrical component to a circuit, the electrical component often must be connected with positive and negative polarities properly aligned. Proper alignment of the polarities is particularly important in direct current (“DC”) circuits. For example, a battery must be properly connected to a DC circuit by matching polarities for the circuit to function correctly and prevent damage to the battery or the circuit itself.

To properly connect electrical components to a circuit, connector systems are often used Conventional connector systems are configured to terminate an electrical cable and provide electrical and mechanical connection to a terminal of the electrical component or the circuit. However, conventional connector systems have several disadvantages. The conventional connector system can allow the cable to be connected to an electrical terminal of the component that is of opposite polarity. For example, the conventional battery for an automobile has identical electrical terminals that are often only differentiated by color. Thus it is possible that a negative cable can be connected to the positive terminal of the battery or vice versa. Also, electrical terminals that are often positioned close to one another and can be subject to electrical shorts caused by a conductor inadvertently electrically connecting the electrical terminals. For example, the terminals of conventional automobile batteries can be shorted by the metallic shaft of a screwdriver inadvertently left on the battery. Furthermore, conventional connector systems do not provide protection from electrical shock. Often conductive components are exposed or covered only by insulation that provides minimal protection. Additionally, conventional connector systems arc often difficult to connect to electrical terminals. In the example of a vehicle battery, a tool must be used to tighten bolts to connect the cables to the terminals.

Thus, a need in the art exists for an improved connector system that ensures that the correct cable is connected to the proper terminal, prevents electrical shorts from developing between terminals, provides protection against electrical shock, and facilitates connection.

### SUMMARY OF THE INVENTION

Accordingly, it is an aspect of the invention to provide a connector system for connecting cables to terminals of an electrical device, wherein the cable connectors have components that are configured so that they are not interchangeable, prevent electrical shorts from developing, provide protection against electrical shock, and facilitate mating.

One embodiment of the present invention provides a connector system for connecting cables to terminals of an electrical device. The connector system includes a first cable connector terminating a first cable; a first terminal connector mateable with the first cable connector, the first terminal connector configured to couple to a first terminal of the electrical device; a second cable connector terminating a second cable; and a second terminal connector mateable with the second cable connector, the second terminal connector configured to couple to a second terminal of the electrical device, wherein the first cable connector and the second cable connector are different such that the first cable connector is not mateable with the second terminal connector and the second cable connector is not mateable with the first terminal connector.

Another embodiment of the present invention provides a connector system for connecting cables to terminals of a battery. The connector system includes a first cable connector terminating a first cable; a first battery connector configured to mate with the first cable connector, the first battery connector coupled to a first terminal of the battery; a second cable connector terminating a second cable; and a second battery connector configured to mate with the second cable connector, the second battery connector coupled to a second terminal of the battery; wherein the first and second cable connectors are different such that the first cable connector is not mateable with the second battery connector and the second cable connector is not mateable with the first battery connector.

Yet another embodiment of the present invention provides a connector system for connecting cables to terminals of an electrical device. The connector system includes a male plug connector terminating a first cable; a female receptacle connector mateable with the male plug connector, the female receptacle connector configured to couple to a first terminal of the electrical device; a female plug connector terminating a second cable; a male receptacle connector mateable with the female plug connector, the male receptacle connector configured to couple to a second terminal of the electrical device; a first latch disposed on one of the first cable connector or the first terminal connector; a first catch disposed on one of the first terminal connector or the first cable connector to receive the first latch to latch the first cable connector to the first terminal connector; a second latch disposed on one of the second cable connector or the second terminal connector; a second catch disposed on one of the second terminal connector or the second cable connector to receive the second latch to latch together the second cable connector to the second terminal connector; and a strain relief member disposed on at least one of the first cable connector and the second cable connector, the strain relief member configured to receive and support a cable.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a top perspective view of a connector assembly according to an exemplary embodiment of the present invention;

FIG. 2 is a top plan view of the connector assembly illustrated in FIG. 1;

FIG. 3 is a perspective view of unmated cable connectors and terminal connectors of the connector system illustrated in FIG. 1;

FIG. 4 is a perspective view of a first terminal connector with female receptacle of the connector system illustrated in FIG. 1;

FIG. 5 is a perspective view of the first terminal connector illustrated in FIG. 4 without insulation;

FIG. 6 is a perspective view of a second terminal connector of the connector system illustrated in FIG. 1;

FIG. 7 is a perspective view of a second terminal connector illustrated in FIG. 6 without insulation;

FIG. 8 is a perspective view of a first cable connector of the connector system illustrated in FIG. 1;

FIG. 9 is a perspective view of a second cable connector of the connector system illustrated in FIG. 1;

FIG. 10 is a perspective view of a cable connector with a male plug according to an alternate embodiment of the present invention; and

FIG. 11 is a perspective view of a cable connector with a female plug according to an alternate embodiment of the present invention.

### DETAILED DESCRIPTION OF THE INVENTION

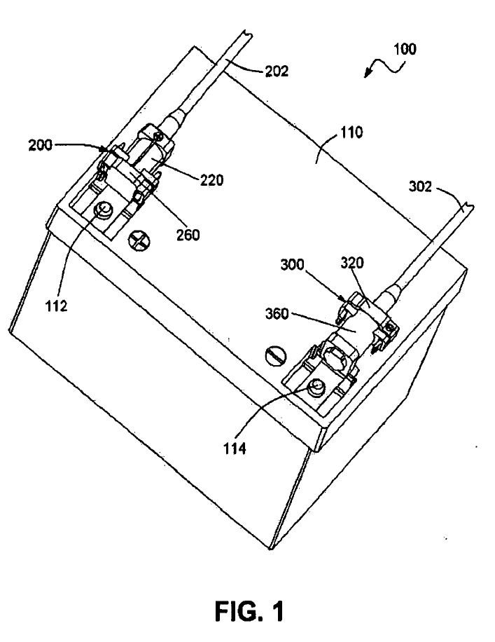

Referring to FIGS. 1-11, a connection system 100 for connecting cables 202 and 302 to an electrical device 110, such as a battery, for example, in accordance with the present invention includes, at least, a first connector assembly 200 and a second connector assembly 300. The components of the first and second connector assemblies 200 and 300 are configured so that they are not interchangeable, that is, positive-polarity components are unmateable with negative-polarity components. Thus, the connector system 100 ensures that the cables 202 and 302 are connected to their proper respective terminal 112 or 114 of the device 110. Also, the components of the first and second connector assemblies 200 and 300 are configured to be easily mated or unmated by hand without the use of a tool. Once mated, the first and second connector assemblies 200 and 300 envelop their electrically conductive components; thus, the connector system 100 prevents electrical shorts from developing between terminals 112 and 114 and provides protection against electrical shock.

Referring to FIG. 1, the first connector assembly 200 includes, at least, a first cable connector 220 and a first terminal connector 260. The first cable connector 220 terminates the cable 202, and the first terminal connector 260 is connected to a first terminal 112 of the electrical device 110. Thus, the first connector assembly 200 provides an electrical pathway between the cable 202 and the first terminal 112 of the device 110. The second connector assembly 300 includes, at least, a second cable connector 320 and a second terminal connector 360. The second cable connector 320 terminates the cable 302, and the second terminal connector 360 is connected to a second terminal 114 of the electrical device 110. Thus, the second connector assembly 300 provides an electrical pathway between the cable 302 and the second terminal 114 of the device 110.

Although, the electrical device 110 is shown as a battery, the electrical device 110 may be any device with electrical terminals, such as, but not limited to, generators, capacitors, meters, or solid state components. If the electrical device 110 is a battery, the battery can be a wet cell battery, a dry cell battery, a lead acid battery, a non-spillable sealed lead acid battery, a valve regulated lead acid battery, a recombinant battery, a nickel-cadmium battery, a nickel metal hydride battery, a lithium ion battery, a lithium ion polymer battery, a zinc air battery, a molten salt battery, or any other device that chemically stores electrical energy.

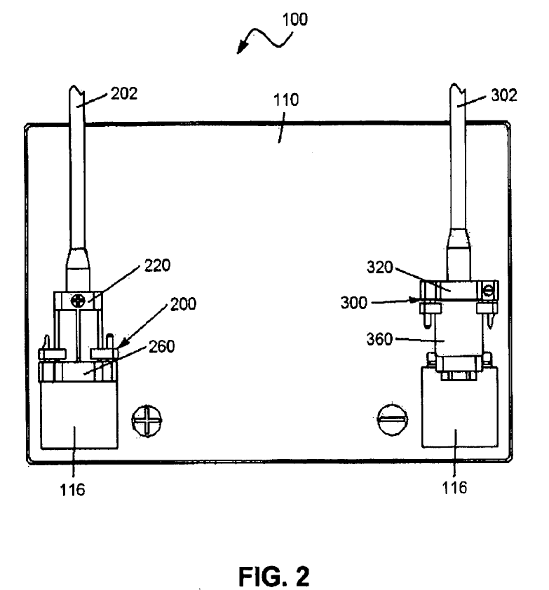

Referring to FIG. 2, the first and second terminals 112 and 114 are preferably covered by an insulating cover 116. The insulating cover 116 can be made from any material with high electrical resistance.

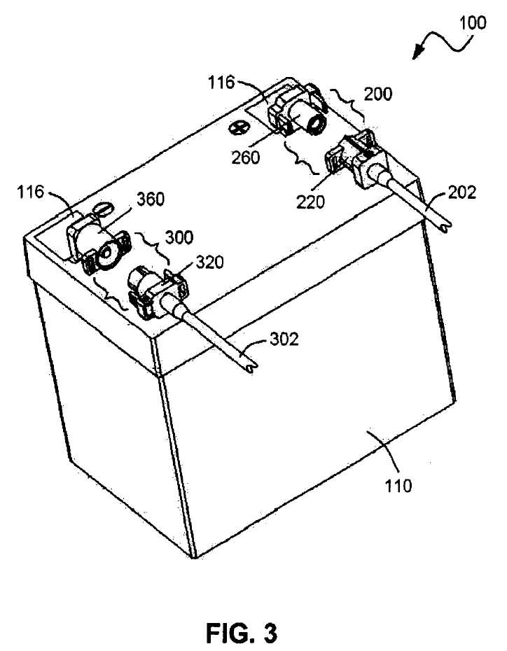

Referring to FIG. 3, one of the terminal connectors 260 or 360 includes a male receptacle while the other includes a female receptacle, and the first and second cable connectors 220 and 320 include a corresponding male plug or female plug. Thus, for example, in the embodiment depicted, the first terminal connector 260 includes the female receptacle, and the second terminal connector 360 includes the male receptacle. Therefore, the first cable connector 220 includes the male plug to mate with the female receptacle of the first terminal connector 260, and the second cable connector 320 includes the female plug to mate with the male receptacle of the second terminal connector 360. Consequently, the first cable connector 220 and the second cable connector 320 are different such that the first cable connector 220 is not mateable with the second terminal connector 360 and the second cable connector 320 is not mateable with the first terminal connector 260.

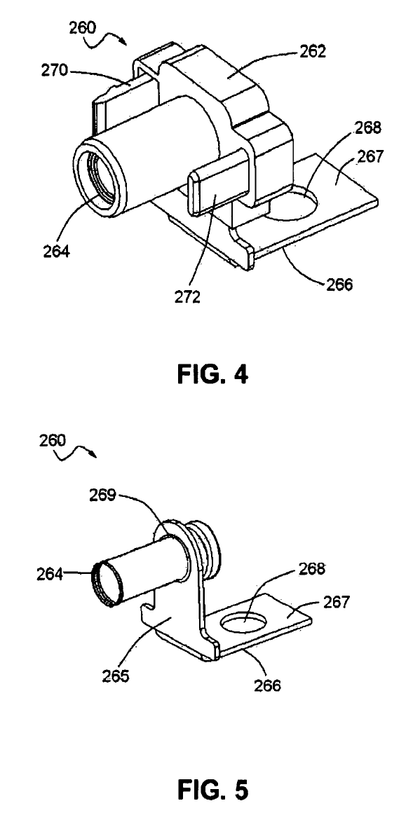

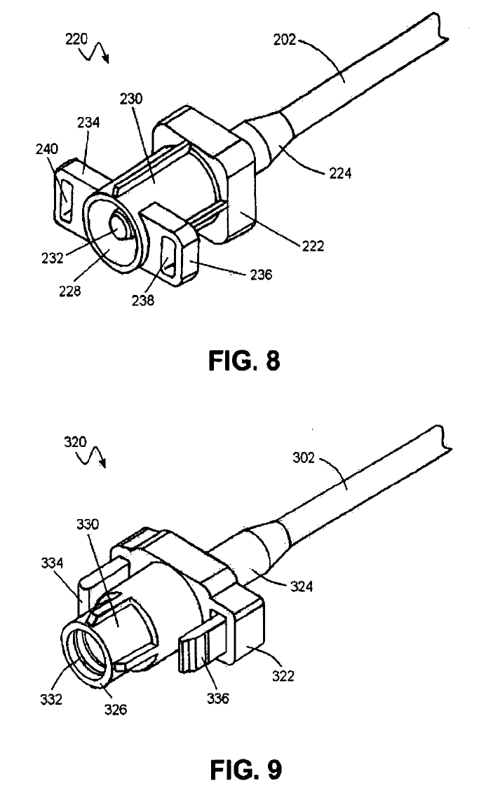

Referring to FIG. 4, the first terminal connector 260 with the female receptacle is shown. Although the terminal connector shown is called the first terminal connector 260 to simplify and facilitate the description of the invention, in an alternative embodiment the terminal connector can be the second terminal connector 360 with the female receptacle. The first terminal connector 260 includes a conductive socket 264 and an oppositely extending terminal contact 266. The conductive socket 264 can be made from any conductive material. Preferably, the conductive socket 264 is a RADSOK® socket which is a cylindrical socket with several equally spaced longitudinal beams twisted into a curved shape that provides high current flow with low voltage drop. The conductive socket 264 can also be a socket with multiple ports or any other conductive structure that receives a conductive body. The shape of the conductive socket 264 is configured to receive the male plug. In the depicted embodiment, the conductive socket 264 has a generally hollow cylindrical shape with a substantially circular cross-section. Alternatively, the conductive socket 264 can be a hollow body with a substantially polygonal shape in cross-section or any other suitable form for accepting its corresponding male counterpart. The conductive socket 264 is formed to accept corresponding conductive pin 232 (shown in FIG. 8) and form an electrical pathway between the cable 202 and the terminal 112.

The terminal contact 266 can be, as shown, a conductive plate 267 with a hole 268 adapted to receive a post-like terminal. The hole 268 receives the terminal 112 of the electrical device 110 and then the terminal 112 may be soldered to the hole 268. If the terminal 112 is recessed, as shown in the battery of FIG. 1, the conductive plate 267 can be covered with epoxy to form the insulating cover 116. In alternative embodiments, the terminal contact 266 can be made from any conductive material and formed to be a contact tail adapted for soldering, a press-fit contact, a pressure-mount contact, a crimp-on contact, or another similar electrical coupling to a terminal.

The first terminal connector 260 may be substantially encased in insulation 262. In the exemplary embodiment depicted, the conductive socket 264 is encased in the insulation 262, but the terminal contact 266 is not encased in insulation 262 to facilitate electrical coupling of the terminal contact 266 with the terminal 112. Preferably, the insulation 262 is disposed on the first terminal connector 260 by insert molding. The insulation 262 can be made of any material with high electrical resistance.

The first terminal connector 260 can also include a latch 270 to latch the first terminal connector 260 and the first cable connector 220 to each other. The latch 270 is configured to couple with a corresponding catch 236 (shown in FIG. 8) on the first cable connector 220. In the embodiment shown, the latch 270 is a latching pin that extends from the insulation 262. The latching pin can be received by an opening 238 (shown in FIG. 8) on the first cable connector 220. When the latching pin is received in the opening 238, the first terminal connector 260 and the first cable connector 220 are latched together. The latch 270 can be made from any suitably rigid material. The latch 270 may be formed integrally with the insulation 262 or formed separately and attached to the insulation 262. The latch 270 can be shaped to snap into the opening 238 of the catch 236, as shown. Alternatively, the latch 270 can be formed to hook, grab, ensnare, envelop, or pierce the catch 236.

The first terminal connector 260 can also include a guide pin 272 that extends from the insulation 262. The guide pin 272 can be received in opening 240 (shown in FIG. 8). The guide pin 272 can align the first terminal connector 260 and the first cable connector 220 with respect to each other. The guide pin 272 may be formed integrally with the insulation 262 or formed separately and attached to the insulation 262. Alternatively, the first terminal connector 260 can have two latches 270 rather than one latch 270 and one guide pin 272 as shown in FIG. 4.

Referring to FIG. 5, the first terminal connector 260 is shown without insulation 262. An intermediate portion 265 provides an electrical pathway between the conductive socket 264 and the terminal contact 266. The intermediate portion 265 can also provide rigid mechanical support to the conductive socket 264 and the terminal contact 266. Preferably, the intermediate portion 265 is made from any rigid, conductive material.

The conductive socket 264, the intermediate portion 265, and the terminal contact 266 can be formed integrally with each other, formed separately and then coupled, or any combination thereof. In the embodiment shown, the intermediate portion 265 and the terminal contact 266 are formed integrally with the intermediate portion 265 being substantially orthogonal to the terminal contact 266. The intermediate portion 265 also has an aperture 269 that receives a separately formed conductive socket 264. Preferably, the terminal contact 266, the intermediate portion 265, and the aperture 269 are formed by stamping. A press-fit conductive socket 264 can be inserted into the aperture 269 and thus extend substantially orthogonally with respect to the intermediate portion 265.

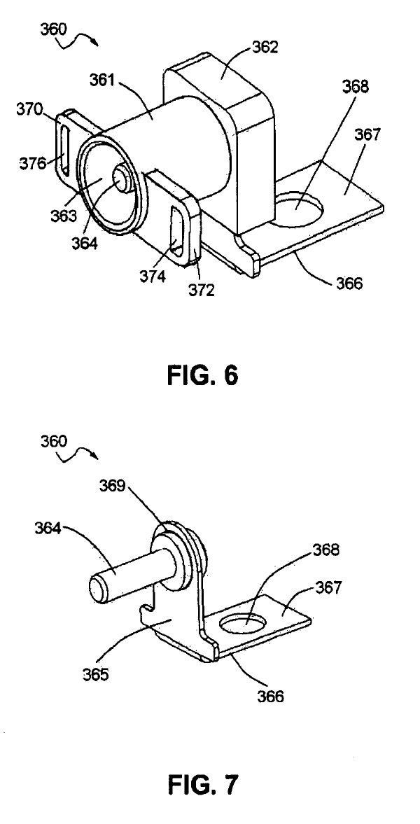

Referring to FIG. 6, the second terminal connector 360 with the male receptacle is shown. Although the terminal connector shown is called the second terminal connector 360 to simplify and facilitate the description of the invention, in an alternate embodiment the terminal connector can be the first terminal connector 260 with the male receptacle. The second terminal connector 360 includes a conductive pin 364 and an oppositely extending terminal contact 366. The conductive pin 364 can be a RADSOK® pin, multiple pins, or any other conductive body that can be inserted into another conductive structure. The shape of the conductive pin 364 is configured to be received by a conductive socket 322 (shown in FIG. 9) of the second cable connector 320. The terminal contact 366 is substantially similar to the terminal contact 266 of the first terminal connector 260, therefore a detailed description thereof is omitted.

The second terminal connector 360 is substantially encased in insulation 362. In the embodiment shown, the insulation 362 forms an insulative jacket 361 spaced apart and surrounding the conductive pin 364, thus forming a receiving area 363 between the conductive pin 364 and the insulative jacket 361. The receiving area 363 is adapted to receive the conductive socket 332 (shown in FIG. 9) of the second cable connector 320. In the embodiment depicted, the insulative jacket 361 has a hollow, substantially cylindrical shape around the conductive pin 364 and the receiving area 363 is sized to receive the conductive socket 332 and an insulative jacket 330 (both shown in FIG. 9) of the second cable connector 320. In alternative embodiments, the insulative jacket 361 can be a hollow body with a polygonal shape in cross-section or any other suitable form for accepting a counterpart female plug. The insulation 362 and insulative jacket 361 can be made of any material with high electrical resistance. The insulative jacket 361 can be formed integrally with the insulation 362, or the insulative jacket 361 can be formed separately and coupled to the insulation 362. Preferably, the insulation 362 and the insulative jacket 361 are disposed on the second terminal connector 362 by insert molding.

The second terminal connector 360 can include a catch 370 to accept a latch 336 (shown in FIG. 9) of the second cable connector 320. In the embodiment shown, the catch 370 is a tab that extends from the insulative jacket 361 and has an opening 376. The opening 376 is formed to receive the latch 336 (shown in FIG. 9). The opening 376 can also be formed to receive a guide pin 334 (shown in FIG. 9) of the second cable connector 320. The catch 370 is made of any suitable rigid material. The second terminal connector 360 can have an additional catch 372 that is substantially similar to the catch 370. Because the additional catch 372 is substantially similar to the catch 370, a detailed description of the additional catch 372 is omitted.

Referring to FIG. 7, the second terminal connector 360 is shown without the insulation 362. An intermediate portion 365 provides an electrical pathway between the conductive pin 364 and the terminal contact 366. The intermediate portion 365 can be substantially the same as the intermediate portion 265 of the first terminal connector 260. In the embodiment shown, the intermediate portion 365 provides an electrical pathway between a conductive pin 364 and a conductive plate 366 with a hole 368.

Also, in the depicted embodiment, the conductive pin 364 has a generally cylindrical shape with a substantially circular cross-section. In alternate embodiments, the conductive pin 364 can be an elongated body with a polygonal shape in cross-section or any other suitable form for inserting into its counterpart female plug. The conductive pin 364 is formed to be inserted into its corresponding conductive socket 332 (shown in FIG. 9) and form an electrical pathway between the cable 302 and the terminal 114. The conductive pin 364 is made from any suitable conductive material.

The conductive pin 364, the intermediate portion 365, and the terminal contact 366 can be formed integrally with each other, formed separately and then coupled, or any combination thereof. In the embodiment shown, the intermediate portion 365 and the terminal contact 366 are formed integrally with the intermediate portion 365 substantially orthogonal to the terminal contact 366. The intermediate portion 365 also has an aperture 369 that receives a separately formed conductive pin 364. Preferably, the terminal contact 366, the intermediate portion 365, and the aperture 369 are formed by stamping. A press-fit conductive pin 364 can be inserted into the aperture 369 and thus extend substantially orthogonally with respect to the intermediate portion 365.

Referring to FIG. 8, the first cable connector 220 with the male plug is shown. Although the cable connector shown is called the first cable connector 220 to simplify and facilitate the description of the invention, in an alternate embodiment the cable connector can be the second cable connector 320 with the mile plug. The cable connector 220 includes a body 222 with a first end 224 terminating the cable 202 and an opposite second end 226. The body 222 can be formed of any insulative material. The first end 224 is sized to accept, for example, 8, 10, or 12 AWG wire.

The second end 226 has a conductive pin 232, an insulative jacket 230 spaced apart from and surrounding the conductive pin 232, and a receiving area 228 formed therebetween. The conductive pin 232 has a generally cylindrical shape with a substantially circular cross-section. In alternate embodiments, the conductive pin 232 can be an elongated body with a polygonal shape in cross-section or any other suitable form for inserting into its counterpart female receptacle. The conductive pin 232 is formed to be inserted into its corresponding conductive socket 264 (shown in FIGS. 4 and 5) and form an electrical pathway between the cable 202 and the terminal 112. The conductive pin 232 is made from any suitable conductive material.

The receiving area 228 is adapted to receive the conductive socket 264 (shown in FIGS. 4 and 5) of the first terminal connector 220. In the embodiment depicted, the insulative jacket 230 has a hollow, substantially cylindrical shape around the conductive pin 228, but in alternative embodiments, the insulative jacket 230 can be a hollow body with a polygonal shape in cross-section or any other suitable form for accepting its counterpart female receptacle. The insulative jacket 230 can be made of any material with high electrical resistance.

The first cable connector 220 can have a catch 236. The catch 236 is configured to receive the latch 270 (shown in FIG. 4) of the first terminal connector 260. In the embodiment shown, the catch 236 is a tab that extends from the insulative jacket 230. The tab includes an opening 238 to receive the latch 270. The first cable connector 220 can have an additional catch 234 that is substantially the same as the catch 236. Because the additional catch 234 is substantially the same as the catch 236, a detailed description of the additional catch 234 is omitted. In the depicted embodiment, the opening 238 can receive either the latching pin 270 or the guide pin 272 of the first terminal connector 260.

Referring to FIG. 9, the second cable connector 320 with the female plug is shown. Although the cable connector shown is called the second cable connector 320 to simplify and facilitate the description of the invention, in an alternate embodiment the cable connector can be the first cable connector 220 with the female plug. The cable connector 320 includes a body 322 with a first end 324 terminating cable 302 and an opposite second end 326. The body 322 can be formed of any insulative material. The first end 324 is sized to accept, for example, 8, 10, or 12 AWG wire.

The second end 326 has a conductive socket 332 and an insulative jacket 330 surrounding the conductive socket 332. The conductive socket 332 can be made from any conductive material and can be a RADSOK® socket, a socket with multiple ports, or any other conductive structure that receives a conductive body. The shape of the conductive socket 332 is configured to receive the male receptacle. In the depicted embodiment, the conductive socket 332 has a generally hollow cylindrical shape with a substantially circular cross-section. Alternatively, the conductive socket 332 can be a hollow body with a substantially polygonal shape in cross-section or any other suitable form for accepting its corresponding male counterpart. The conductive socket 332 is formed to accept its corresponding conductive pin 364 (shown in FIGS. 6 and 7) and form an electrical pathway between the cable 302 and the terminal 114 of the device 110. The insulative jacket 330 encases the conductive socket 332 and extends from the body 322. The insulative jacket 330 can be made of any material with high electrical resistance.

The second cable connector 320 can include a latch 336 and a guide pin 334. Alternatively, the second cable connector 320 can have two latches 336, instead of the latch 336 and the guide pin 334, as shown in FIG. 9. The latch 336 extends from the body 322. The latch 336 is configured to couple with its corresponding catch 370 (shown in FIG. 6) on the second terminal connector 360. In the embodiment shown, the latch 336 is a latching pin that extends from the body 322. The latching pin can be received by the opening 376 (shown in FIG. 6) on the second terminal connector 360. When the latching pin is received in the opening 376, the second cable connector 320 and the second terminal connector 360 are latched together. The latch 336 can be made from any suitably rigid material. The latch 336 may be formed integrally with the body 322 or formed separately and attached to the body 322. The latch 336 can be shaped to snap into the opening 376 of the catch 370, as shown. Alternatively, the latch 336 can be formed to hook, grab, ensnare, envelop, or pierce the catch 370.

The guide pin 334 extends form the body 322. The guide pin 334 can be received in opening 374 (shown in FIG. 6). The guide pin 334 can align the second cable connector 320 and the second terminal connector 360 with respect to each other. The guide pin 334 may be formed integrally with the body 322 or formed separately and attached to the body 322.

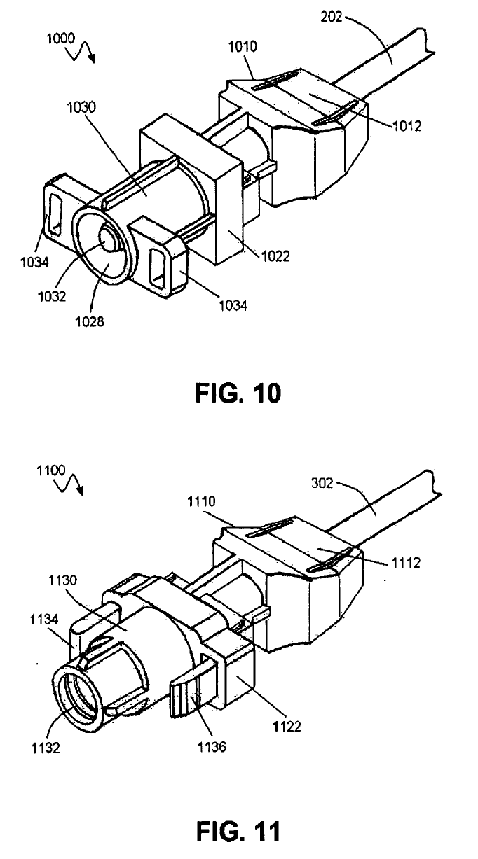

Referring to FIG. 10, a cable connector 1000 with a male plug according to an alternate embodiment is shown. Unlike the first cable connector 220, the cable connector 1000 includes a strain relief member 1010. The strain relief member 1010 extends from the body 1022 and surrounds the cable 202. The strain relief member 1010 can also include a gripping surface 1012. The gripping surface 1012 can be smooth or have ridges, grooves, knurls, combinations of the aforementioned, and the like. The strain relief member 1010 can be formed integrally with the body 1022 or formed separately and then attached to the body 1022. Preferably, the strain relief member 1010 is formed integrally with the body 1022 by insert molding.

The cable connector 1000 also includes a conductive pin 1032, an insulative jacket 1030, and a receiving area 1028. The conductive pin 1032, the insulative jacket 1030, and the receiving area 1028 are substantially similar to the conductive pin 232, the insulative jacket 230, and the receiving area 228 (each shown in FIG. 8) of the first cable connector 220. Therefore, a detailed description of those components is omitted. The cable connector 1000 can include a catch 1034, as shown in FIG. 10. The catch 1034 is substantially similar to the catch 234 of the first cable connector 220, and thus, a detailed description thereof is omitted.

Referring to FIG. 11, a cable connector 1100 with a female plug according to an alternate embodiment is shown. Unlike the second cable connector 320, the cable connector 1100 includes a strain relief member 1110. The strain relief member 1110 extends from the body 1122 and surrounds cable 302. The strain relief member 1110 can also include a gripping surface 1112. The gripping surface 1012 can be smooth or have ridges, grooves, knurls, combinations of the aforementioned, and the like. The strain relief member 1110 can be formed integrally with the body 1122 or formed separately and then attached to the body 1122. Preferably, the strain relief member 1110 is formed integrally with the body 1122 by insert molding.

The cable connector 1100 also includes a conductive socket 1132 and an insulative jacket 1130. The conductive socket 1132 and the insulative jacket 1130 are substantially similar to the conductive socket 332 and the insulative jacket 330 (both shown in FIG. 9) of the second cable connector 320. Therefore, a detailed description of those components is omitted. The cable connector 1100 can include a latch 1136, a guide pin 1134, or both. The latch 1136 and the guide pin 1134 are substantially similar to the latch 336 and the guide pin 334 (both shown in FIG. 9), and so a detailed description thereof is omitted. The catch 1034 is substantially similar to the catch 234 of the first cable connector 220, and thus, a detailed description thereof is omitted. Alternatively, the cable connector 1100 can have two latches 1136 rather than the latch 1136 and guide pin 1134, as shown in FIG. 11.

While particular embodiments have been chosen to illustrate the invention, it will be understood by those skilled in the art that various changes and modifications can be made therein without departing from the scope of the invention as defined in the appended claims.

What is claimed is:

1. A connector system for connecting cables to terminals of an electrical device, comprising of:
a first cable connector terminating a first cable;
a first terminal connector mateable with said first cable connector, said first terminal connector configured to couple to a first terminal of said electrical device;
a second cable connector terminating a second cable; and
a second terminal connector mateable with said second cable connector, said second terminal connector configured to couple to a second terminal of said electrical device,
wherein said first cable connector and said second cable connector are different such that said first cable connector is not mateable with said second terminal connector and said second cable connector is not mateable with said first terminal connector.

2. The connector system according to claim 1, wherein
said first cable connector is a male plug and said first terminal connector is a female receptacle; and
said second cable connector is a female plug, and said second terminal connector is a male receptacle.

3. The connector system according to claim 1, wherein
said first cable connector includes a conductive pin surrounded by an insulative jacket forming a receiving area therebetween; and
said first terminal connector includes a conductive socket, said socket being received in said receiving area when said first cable connector and said first terminal connector are mated.

4. The connector system according to claim 3, wherein said insulative jacket surrounds said conductive pin and said conductive socket when said first cable connector and said first terminal connector are mated.

5. The connector system according to claim 1, wherein
said second cable connector includes a conductive socket; and
said second terminal connector includes a conductive pin surrounded by an insulative jacket forming a receiving area that receives said conductive socket when said second cable connector and said second terminal connector are mated.

6. The connector system according to claim 4, wherein said insulative jacket surrounds said conductive pin and said conductive socket when said second cable connector and second terminal connector are mated.

7. The connector system according to claim 1, further comprising:
a first latch disposed on one of said first cable connector or said first terminal connector;
a first catch disposed on one of said first terminal connector or said first cable connector to receive said first latch to latch said first cable connector to said first terminal connector;
a second latch disposed on one of said second cable connector or said second terminal connector; and
a second catch disposed on one of said second terminal connector or said second cable connector to receive said second latch to latch together said second cable connector to said second terminal connector.

8. The connector system according to claim 7, wherein
said first latch and said second latch are latching pins; and
said first catch and said second catch are openings formed in a tab formed on at least one of said first cable connector, said first terminal connector, said second cable connector, or said second terminal connector.

9. The connector system according to claim 1, further comprising a strain relief member disposed on at least one of said first cable connector and said second cable connector, said strain relief member configured to receive and support a cable.

10. A connector system for connecting cables to terminals of a battery, comprising of:
a first cable connector terminating a first cable;
a first battery connector configured to mate with said first cable connector, said first battery connector coupled to a first terminal of said battery;
a second cable connector terminating a second cable; and
a second battery connector configured to mate with said second cable connector, said second battery connector coupled to a second terminal of said battery;
wherein said first and second cable connectors are different such that said first cable connector is not mateable with said second battery connector and said second cable connector is not mateable with said first battery connector.

11. The connector system according to claim 10, wherein
said first cable connector is a male plug and said first terminal connector is a female receptacle; and
said second cable connector is a female plug, and said second terminal connector is a male receptacle.

12. The connector system according to claim 11, wherein
said male plug includes a conductive pin surrounded by an insulative jacket forming a receiving area therebetween; and
said female receptacle includes a conductive socket, said socket being received in said receiving area when said male plug and female receptacle are mated.

13. The connector system according to claim 12, wherein said insulative jacket surrounds said conductive pin and said conductive socket when said male plug and said female receptacle are mated.

14. The connector system according to claim 11, wherein
said female plug includes a conductive socket; and
said male receptacle includes a conductive pin surrounded by an insulative jacket forming a receiving area that receives said conductive socket when said female plug and male receptacle are mated.

15. The connector system according to claim 13, wherein said insulative jacket surrounds said conductive pin and said conductive socket when said female plug and said male receptacle are mated.

16. The connector system according to claim 10, further comprising:
a first latch disposed on one of said first cable connector or said first terminal connector,
a first catch disposed on one of said first terminal connector or said first cable connector to receive said first latch to latch said first cable connector to said first terminal connector;
a second latch disposed on one of said second cable connector or said second terminal connector, and
a second catch disposed on one of said second terminal connector or said second cable connector to receive said second latch to latch together said second cable connector to said second terminal connector.

17. The connector system according to claim 16, wherein
said first latch and said second latch are latching pins; and
said first catch and said second catch are openings formed in a tab formed on at least one of said first cable connector, said first terminal connector, said second cable connector, or said second terminal connector.

18. The connector system according to claim 10, further comprising a strain relief member disposed on at least one of said first cable connector and said second cable connector, said strain relief member configured to receive and support a cable.

19. A connector system for connecting cables to terminals of an electrical device, comprising of:
a male plug connector terminating a first cable;
a female receptacle connector mateable with said male plug connector, said female receptacle connector configured to couple to a first terminal of said electrical device;
a female plug connector terminating a second cable;
a male receptacle connector mateable with said female plug connector, said male receptacle connector configured to couple to a second terminal of said electrical device;
a first latch disposed on one of said first cable connector or said first terminal connector;
a first catch disposed on one of said first terminal connector or said first cable connector to receive said first latch to latch said first cable connector to said first terminal connector;
a second latch disposed on one of said second cable connector or said second terminal connector;
a second catch disposed on one of said second terminal connector or said second cable connector to receive said second latch to latch together said second cable connector to said second terminal connector; and
a strain relief member disposed on at least one of said first cable connector and said second cable connector, said strain relief member configured to receive and support a cable.

20. The connector system according to claim 19, wherein
said male plug includes a conductive pin surrounded by an insulative jacket forming a receiving area therebetween; and
said female receptacle includes a conductive socket, said socket being received in said receiving area when said male plug and female receptacle are mated.

21. The connector system according to claim 19, wherein
said female plug includes a conductive socket; and
said male receptacle includes a conductive pin surrounded by an insulative jacket forming a receiving area that receives said conductive socket when said female plug and male receptacle are mated.
